(19) United States
(12) Patent Application Publication
(10) Pub. No.: US 2026/0180426 A1
(43) Pub. Date: Jun. 25, 2026

(54) DRIVING CIRCUIT FOR A SWITCHING CIRCUIT, HAVING IMPROVED DRIVING PERFORMANCE

(71) Applicant: STMicroelectronics International N.V., Geneva (CH)

(72) Inventors: Giovanni Sicurella, Catania (CT) (IT); Andrea Villot, Aosta (IT); Francesco Giorgio, Brolo (IT)

(21) Appl. No.: 19/422,228

(22) Filed: Dec. 16, 2025

(30) Foreign Application Priority Data
Dec. 24, 2024 (IT) 102024000029964

(51) Int. Cl. H02M 1/08; H02M 3/158

(52) U.S. Cl. CPC H02M 1/08; H02M 3/158

(57) ABSTRACT

In embodiments, a driving circuit is provided for a switching circuit arranged between an input node at an input voltage and a reference potential node, and including a high-side switch circuit and a low-side switch circuit. The driving circuit has a high-side driver with a first supply node couplable to the input node, at least one output couplable to the high-side switch circuit, and configured to switch the high-side switch circuit. The driving circuit has a low-side driver with a first supply node couplable to the input node, at least one output couplable to the low-side switch circuit, and configured to switch the low-side switch circuit.

### CROSS-REFERENCE TO RELATED APPLICATIONS

This application claims priority to Italian Application No. 102024000029964, filed on December 24, 2024, which application is hereby incorporated by reference herein in its entirety.

### TECHNICAL FIELD

The present disclosure relates to a driving circuit for a switching circuit, and in embodiments, to a switching circuit of a switching voltage converter, having improved driving performance. In certain embodiments, it refers to a driving circuit for a switching circuit of a DC/DC voltage converter.

### BACKGROUND

FIG. 1 illustrates a schematic of a voltage converter 1. The voltage converter 1 comprises a half-bridge circuit 5, which forms the switching circuit of the voltage converter 1, and a driving circuit 7 that switches the half-bridge circuit 5 as a function of a high-side control signal HS_PWM and a low-side control signal LS_PWM.

The high-side control signal HS_PWM and the low-side control signal LS_PWM are generated by further components of the voltage converter 1, not shown here, so that the output voltage VOUT is kept equal to a desired nominal value.

The half-bridge 5 comprises a high-side switch HS’, formed by an NMOS transistor 8 and a parasitic diode 9 associated with the NMOS transistor 8, and a low-side switch LS’, formed by an NMOS transistor 10 and a parasitic diode 11 associated with the NMOS transistor 10, mutually coupled between the input voltage VIN and the ground GND.

A phase node SW is arranged between the high-side switch HS’ and the low-side switch LS’. An inductor L and a capacitor C are coupled to the phase node SW, at the output of the half-bridge 5. The output voltage VOUT drops across the capacitor C. A bootstrap capacitor CBOOT is coupled between a bootstrap node BOOT of the voltage converter 1 and the phase node SW.

The driving circuit 7 also comprises an internal voltage regulator 13, which is supplied by the input voltage VIN and which provides a driving voltage VDRV to a respective driving node 14, starting from a reference voltage VREF. The driving circuit 7 comprises a high-side driver 16, which opens and closes the high-side switch HS’ as a function of the high-side control signal HS_PWM, and a low-side driver 17, which opens and closes the low-side switch LS’ as a function of the low-side control signal LS_PWM.

The low-side driver 17 is supplied by the driving voltage VDRV. The high-side driver 16 has a supply node 20 which is directly coupled to the bootstrap node BOOT and a supply reference node directly coupled to the phase node SW. A passive diode 22 is arranged between the driving node 14 of the internal voltage regulator 13 and the supply node 20, allowing charging of the bootstrap capacitor CBOOT. The supply node 20 of the high-side driver 16 is at a bootstrap voltage Vboot, which drops across the bootstrap capacitor CBOOT.

The use of NMOS transistors to form the high-side HS’ and low-side LS’ switches of the half-bridge circuit 5 allows obtaining low on-state resistances, compared for example to the use of PMOS transistors, and therefore allows obtaining low power consumption. The bootstrap capacitor CBOOT, in parallel with the high-side driver 16, provides the voltage needed for closing the high-side switch HS’ (i.e., for turning on the respective NMOS transistor 8).

According to an approach, an external capacitor 25 (indicated by a dashed line in FIG. 1), also known as a tank capacitor, may be coupled to the driving node 14 of the internal voltage regulator 13, in such a way as to keep the driving voltage VDRV constant during the use of the voltage converter 1 and in embodiments to avoid oscillations of the driving voltage VDRV during the switching of the half-bridge 5. However, the external capacitor 25 occupies a large portion of the die area, thereby increasing the converter 1’s costs.

In embodiments, integrating the capacitor 25 within the converter 1’s die or within the converter 1’s package entails high production costs for the converter 1. Instead, if the external capacitor 25 is used, an additional pin needs to be provided in the converter 1; however, this is not always possible, due to the resulting increase in the final application’s costs and to the ever-increasing trend towards the miniaturization of such devices.

In the absence of the external capacitor 25, the driving voltage VDRV may exhibit significant oscillations, thereby preventing proper half-bridge switching and causing malfunctions in the driving circuit 7 and reduced switching performance of the known converter 1.

Furthermore, the driving voltage VDRV provided by the internal voltage regulator 13 needs to be able to withstand the turning on of the NMOS transistor 10 of the low-side switch LS’ and the charging of the bootstrap capacitor BOOT when the NMOS transistor 8 of the high-side switch HS’ is off.

In other words, the internal voltage regulator 13, in addition to keeping the oscillations of the driving voltage VDRV low, also needs to be able to provide at the output an amount of current sufficient to switch the low-side driver 17 and charge the bootstrap capacitance when required by the circuit. To do this, the internal voltage regulator 13 occupies a large portion of the die area. Furthermore, to ensure fast switching of the half-bridge circuit 5, the internal voltage regulator 13 needs to have a high bandwidth and, therefore, a high power consumption. Therefore, the known driving circuit 7 has an area occupation and a power consumption that are too high for specific applications. The present disclosure aims to overcome, at least in part, the disadvantages of the prior art.

### SUMMARY

According to the present disclosure, a driving circuit and a method for driving a switching circuit are provided, as defined in the attached claims.

Embodiments can be implemented in hardware, software, or any combination thereof.

### BRIEF DESCRIPTION OF THE DRAWINGS

For a better understanding of the present disclosure, embodiments thereof are now described, purely by way of non-limiting example, with reference to the attached drawings, wherein:

FIG. 1 shows a circuit diagram of a known voltage converter;

FIG. 2 shows a circuit diagram of a voltage converter;

FIG. 3 shows a circuit diagram of a high-side driver of the voltage converter of FIG. 2;

FIG. 4 shows an example of waveforms of the voltage converter of FIG. 2, in use;

FIG. 5 shows a circuit diagram of a portion of the voltage converter of FIG. 2;

FIG. 6 shows a circuit diagram of a voltage converter;

FIG. 7 shows a circuit diagram of a low-side driver of the voltage converter of FIG. 6;

FIG. 8 shows an example of waveforms of the voltage converter of FIG. 6, in use;

FIG. 9 shows a circuit diagram of a driving voltage regulator of the converter of FIG. 2 or FIG. 6;

FIG. 10 shows a circuit diagram of the driving voltage regulator of FIG. 9; and

FIG. 11 shows a circuit diagram of a low-side driver of the voltage converter of FIG. 2.

### DETAILED DESCRIPTION OF ILLUSTRATIVE EMBODIMENTS

This disclosure provides many applicable inventive concepts that can be embodied in a wide variety of specific contexts. The particular embodiments are merely illustrative of specific configurations and do not limit the scope of the claimed embodiments. Features from different embodiments may be combined to form further embodiments unless noted otherwise. Various embodiments are illustrated in the accompanying drawing figures, where identical components and elements are identified by the same reference number, and repetitive descriptions are omitted for brevity.

Variations or modifications described in one of the embodiments may also apply to others. Further, various changes, substitutions, and alterations can be made herein without departing from the spirit and scope of this disclosure as defined by the appended claims.

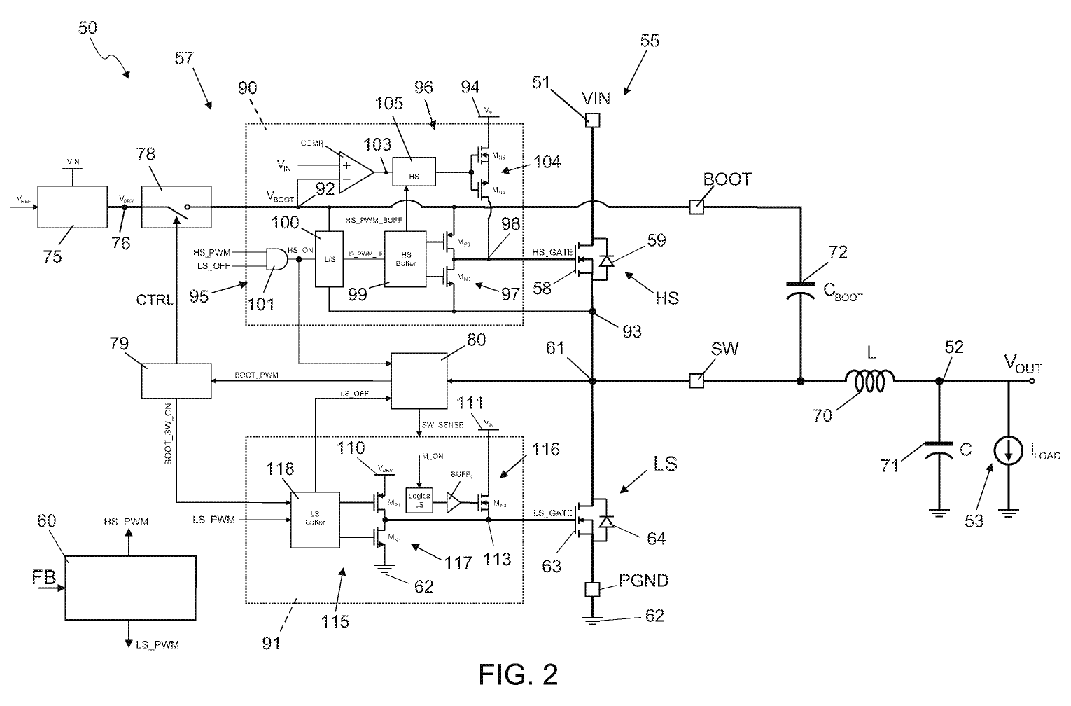

FIG. 2 shows a voltage converter 50 having an input node 51 at an input voltage V_{IN} and an output node 52 at an output voltage V_{OUT}. The voltage converter 50 is configured to provide the voltage V_{OUT} to a load 53, starting from the input voltage V_{IN}. In embodiments, the voltage converter 50 is configured to keep the output voltage V_{OUT} at a nominal value, which may be chosen by a user depending on the specific application.

In the embodiment of FIG. 2, the voltage converter 50 is a switching voltage converter, and in some embodiments of the DC-DC switching voltage converter type. Furthermore, in the embodiment of FIG. 2, the voltage converter 50 is a step-down converter, i.e., configured such that the output voltage V_{OUT} is lower than the input voltage V_{IN}. The voltage converter 50 comprises a switching circuit which, in the embodiment of FIG. 2, is a half-bridge circuit 55; and a driving circuit 57 which controls the switching of the half-bridge circuit 55.

The driving circuit 57 controls switching of the half-bridge circuit 55 as a function of a modulated control signal, and, in some embodiments, also as a function of a high-side control signal HS_PWM and a low-side control signal LS_PWM.

The high-side control signal HS_PWM and the low-side control signal LS_PWM are pulse-width modulated signals, which are generated by a switching control circuit 60 to control the opening and closing durations of the switches of the switching circuit 55, so that the output voltage V_{OUT} is kept equal to the desired nominal value.

For example, the switching control circuit 60 may generate the high-side HS_PWM and low-side LS_PWM control signals as a function of a feedback signal FB indicative of the current value of the output voltage V_{OUT} (and in embodiments indicative of a difference between the output voltage V_{OUT} and the desired nominal value), so that the output voltage V_{OUT} is kept substantially constant and equal to the desired nominal value.

The switching control circuit 60 may be configured to perform a voltage or current control of the voltage converter 50, for example, according to a peak control scheme, valley control scheme or other known control schemes.

The half-bridge circuit 55 comprises a high-side switch circuit HS and a low-side switch circuit LS arranged between the input node 51 and a reference potential node (here at the ground 62 through a ground node PGND of the voltage converter 50). The high-side switch circuit HS, hereinafter also referred to as the high-side switch HS, is arranged between the input node 51 and an intermediate node 61 of the half-bridge circuit 55. The intermediate node 61 forms a phase node SW of the voltage converter 50. The high-side switch HS is formed, in the embodiment shown, by an NMOS transistor 58 and may also comprise a parasitic diode 59 associated with the NMOS transistor 58.

The low-side switch circuit LS (hereinafter, the low-side switch LS) is arranged between the intermediate node 61 and the reference potential node PGND. The low-side switch LS, in the embodiment shown, is formed by an NMOS transistor 63 and may comprise a parasitic diode 64 associated with the NMOS transistor 63.

An inductor 70 of inductance L and an output capacitor 71 of capacitance C are coupled to the phase node SW, at the output of the half-bridge circuit 55. The output voltage V_{OUT} drops across the capacitor 71. The inductor 70 is coupled between the phase node SW and the output node 52, and the capacitor 71 is coupled between the output node 52 and ground.

A bootstrap capacitor 72 of capacitance C_{BOOT} is coupled between the phase node SW and a bootstrap node BOOT of the voltage converter 50. The bootstrap node BOOT is at a voltage V_{boot}.

The driving circuit 57 comprises an internal voltage regulator (hereinafter, the driving voltage regulator) 75, which is supplied by the input voltage V_{IN} and provides a driving voltage V_{DRV} to a respective output node (hereinafter also referred to as the driving node) 76, starting from a reference voltage V_{REF}. The internal voltage regulator 75 may, for example, be a linear regulator. In embodiments, the internal voltage regulator 75 is a capless voltage regulator. In other words, the voltage converter 50 may be free of a dedicated external capacitor (in addition to the bootstrap capacitor 72), which is directly coupled to the respective driving node 76.

The driving circuit 57 comprises a bootstrap switch circuit 78 and a bootstrap control circuit, which is configured to control the bootstrap switch circuit 78 and comprises, in the embodiment of FIG. 2, a control circuit 79 and a sensing circuit 80. The bootstrap switch circuit 78 is coupled between the driving node 76 and the bootstrap node BOOT, and is configured to regulate the coupling between the driving node 76 and the bootstrap node BOOT, as a function of a bootstrap control signal CTRL.

In embodiments, the bootstrap switch circuit 78 is configured to couple the driving node 76 to the bootstrap node BOOT or decouple the driving node 76 from the bootstrap node BOOT, as a function of the bootstrap control signal CTRL. The bootstrap switch circuit 78 has a switching time between a closed state wherein it couples the driving node 76 to the supply node 92 of the high-side driver 90 and an open state wherein it decouples the driving node 76 from the supply node 92; for example, the switching time may be about a few nanoseconds or tens of nanoseconds, depending on the specific configuration and implementation of the bootstrap switch circuit 78. The bootstrap switch circuit 78 may comprise one or more switches, for example, formed by one or more transistors or electrical elements of different types, depending on the specific implementation.

The sensing circuit 80 is coupled to the phase node SW and is configured to monitor the trend of the voltage at the phase node SW and provide, in response, a first regulated signal BOOT_PWM. The sensing circuit 80 is configured to sense when the phase node SW falls below a voltage threshold. Such a voltage threshold may be chosen such that the voltage V_{boot} at the bootstrap node BOOT (which follows the voltage V_{SW} at the phase node SW by means of the bootstrap capacitor 72) is low enough not to damage the internal regulator 75 when the switch 78 closes. For example, such a threshold may be approximately lower than 1 V. In other words, the sensing circuit 80 is configured to sense when the phase node SW has discharged.

In the embodiment of FIG. 2, the sensing circuit 80 is also configured to provide a second regulated signal SW_SENSE (hereinafter, the driver control signal SW_SENSE), indicative of the trend of the voltage at the phase node SW. In practice, the first and the second regulated signals BOOT_PWM and SW_SENSE are sensing signals indicative of the trend of the voltage V_{SW} at the phase node SW.

The control circuit 79 is configured to receive the first regulated signal BOOT_PWM and, in response, provide the bootstrap control signal CTRL. The bootstrap control signal CTRL is configured to close the bootstrap switch circuit 78, in response to sensing, by the sensing circuit 80, that the phase node SW has fallen below the voltage threshold.

The driving circuit 57 comprises a high-side driver 90 that controls the switching (i.e., opening and closing) of the high-side switch HS, and a low-side driver 91 that controls the switching (i.e., opening and closing) of the low-side switch LS. In the embodiment of FIG. 2 wherein the driving circuit 57 is part of the switching voltage converter 50, the high-side driver 90 controls the switching of the high-side switch HS as a function of the high-side control signal HS_PWM and the low-side driver 91 controls the switching of the low-side switch LS as a function of the low-side control signal LS_PWM.

The high-side driver 90 has two supply nodes 92 and 94 and a reference supply node 93. The high-side driver 90 has an output 98, which is coupled to the gate terminal of the NMOS transistor 58 of the high-side switch HS, providing the HS_GATE signal. The supply node 92 is, in embodiments, directly coupled to the bootstrap node BOOT; the supply node 94 is coupled to the input node 51 so that it is at the input voltage V_{IN}. The reference supply node 93 is, in embodiments, directly coupled to the phase node SW.

The high-side driver 90 is configured to couple the high-side switch HS, in embodiments, the gate terminal of the NMOS transistor 58, to the supply node 92 or the supply node 94 for closing the high-side switch HS (i.e., for turning on the respective NMOS transistor 58).

The high-side driver 90 is configured to couple the high-side switch HS, in embodiments, the gate terminal of the NMOS transistor 58, to the reference supply node 93 for opening the high-side switch HS (i.e., for turning off the respective NMOS transistor 58). The high-side driver 90 comprises a coupling circuit 95 which controls the coupling of the high-side switch HS, in embodiments the gate terminal of the respective NMOS transistor 58, to the supply node 92 and the reference supply node 93; and a coupling circuit 96 which controls the coupling of the high-side switch HS, in embodiments the gate terminal of the respective NMOS transistor 58, to the supply node 94.

In the embodiment of FIG. 2, the coupling circuit 95 comprises an output stage 97 arranged between the nodes 92, 93, and, in this embodiment, formed by a PMOS transistor M_{P0} and an NMOS transistor M_{N0}. In embodiments, the output stage 97 may be an inverter (wherein the transistors M_{P0} and M_{N0} have the gate terminals connected and controlled by the same signal); or, the transistors M_{P0} and M_{N0} may be controlled by two different signals generated by a dedicated logic configured to avoid cross-conduction conditions between the two transistors. In embodiments, the output stage 97 is directly coupled to the output 98 of the high-side driver 90.

The output stage 97 is driven by a respective control circuit starting with the high-side control signal HS_PWM, which, in the embodiment shown, comprises a high-side buffer 99, a level shifter circuit 100, and a logic gate 101 (here, an AND logic gate), cascaded together. The high-side buffer 99 may be configured to provide a current sufficient to drive the high-side switch HS, or to implement circuits that avoid cross-conduction in the output stage 97. The level shifter 100 may be configured to allow coupling between the supply domain of the control logic 60 and the high-voltage supply domain (voltages V_{SW} and V_{boot}).

The logic gate 101 may be useful to prevent the output stage 97 from turning on prior to providing the turning off command of the low-side driver 91 (i.e., the logic gate 101 may ensure the turning on of the high-side switch HS only when HS_PWM=1 and LS_OFF=1).

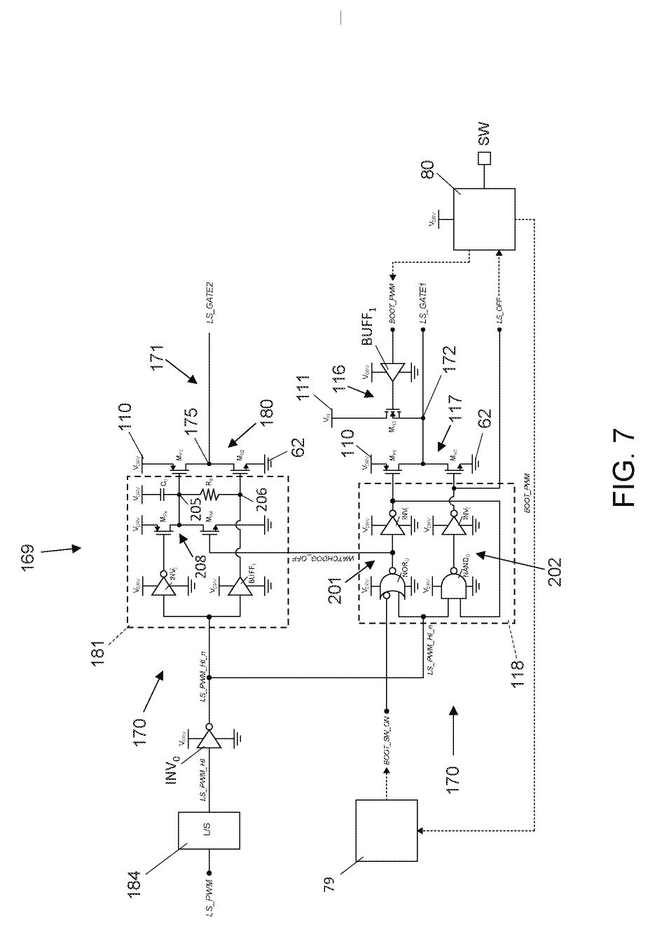

However, the output stage 97 may be controlled by a different circuit, depending on the specific application. The logic gate 101 receives at input the high-side control signal HS_PWM and a logic signal LS_OFF and provides at the output a logic signal HS_ON. The logic signal LS_OFF is indicative of the reception, by the low-side driver 91, of the turning off control signal of the low-side switch LS. The logic signal LS_OFF may be provided, for example, by the low-side driver 91, as shown in the detailed embodiment of FIG. 7.

In practice, the logic signal HS_ON provided by the logic gate 101 may have the logic value ‘high’ when the high-side control signal HS_PWM indicates the closing of the high-side switch HS and the logic signal LS_OFF indicates the opening of the low-side switch LS. This may help prevent the high-side switch HS and the low-side switch LS from turning on simultaneously, thereby avoiding a current path between the input node 51 and the ground node PGND through the half-bridge circuit 55. In embodiments, turning on the signal LS_OFF (for example, switching to the respective logic value ‘high’) may (1) allow the high-side driver 90, through the AND logic gate 101, to enable the turning on of the power MOS 58 at the arrival of the signal HS_PWM. This avoids any possibility of cross-conduction between the power MOS 59 and 63 during the switching of the half-bridge 55 from Toff to Ton, and (2) allows, during the switching of the half-bridge 55 from Ton to Toff, the signal LS_PWM to go from 0 to 1.

This entails the partial switching of the output stage 117 of the low-side driver 91. In practice, the transistor M_{N1} is turned off while the transistor MP1 remains, for the moment, also off, thus leaving the gate terminal of the power MOS 63 in high impedance (≈0V). Concurrently, the signal LS_OFF transitions from 1 to 0, indicating the impending turning on of power MOS 63. The LS_OFF signal enables switching the BOOT_PWM signal in block 80 when the discharge of the phase node SW has fully occurred. Consequently, switch 78 is closed, allowing the boot capacitance to connect to the power supply V_{DRV}. The circuit 79 enables the feedback signal BOOT_SW_ON by signalling that the switching of the switch 78 has occurred. This signal, sent to the circuit 118, allows the completion of the switching of the output stage 117, thus enabling the turning on of the transistor M_{P1}. In this manner, it is possible to ensure that the turning on of the power MOS 63 occurs via the driving signal V_{DRV} only when the bootstrap capacitance C_{BOOT} is connected to the driving signal V_{DRV}.

The coupling circuit 96 is configured, for closing the high-side switch HS, to couple the output 98 of the high-side driver 90 to the supply node 94 as a function of a difference between the input voltage V_{IN} and the boot voltage V_{boot}, in embodiments as long as the input voltage V_{IN} is higher than the boot voltage V_{boot}.

In the embodiment of FIG. 2, the coupling circuit 96 comprises a comparator COMP₀ having an output 103; a series circuit 104 and a logic 105 cascaded between the comparator COMP₀ and the series circuit 104. The comparator COMP₀ compares the input voltage V_{IN} with the boot voltage V_{boot} at the supply node 92.

The series circuit 104 is arranged between the supply node 94 and the output 98 of the high-side driver 90 and comprises two transistors, in embodiments two NMOS transistors, M_{N5} and M_{N6} arranged in a back-to-back configuration with each other. The back-to-back configuration may allow the current flow through the body diodes of the transistors M_{N5} and M_{N6} to be inhibited in both directions when the two transistors are off. The transistors M_{N5}, M_{N6} are driven by the logic 105.

The low-side driver 91 has a supply node 110 which is coupled to the driving node 76 of the internal voltage regulator 75, i.e., it is at the driving voltage V_{DRV}; a supply node 111 which is coupled to the input node 51, i.e., it is at the input voltage V_{IN}; and a reference supply node which is coupled to a reference potential node, in embodiments here to ground and therefore indicated by 62. The low-side driver 91 has an output 113, which is coupled to the gate terminal of the NMOS transistor 63 of the low-side switch LS, to which it provides a signal LS_GATE.

The low-side driver 91 is configured to couple the low-side switch LS, in embodiments, the gate terminal of the NMOS transistor 63, to the supply node 110 or the supply node 111 for closing the low-side switch LS (i.e., to turn on the respective NMOS transistor 63). The low-side driver 91 is configured to couple the low-side switch LS, in embodiments, the gate terminal of the NMOS transistor 63, to the reference supply node 62 for opening the low-side switch LS (i.e., to turn off the respective NMOS transistor 63). The low-side driver 91 comprises a coupling circuit 115 which controls the coupling of the low-side switch LS, in embodiments the gate terminal of the respective NMOS transistor 63, to the supply node 110 and the reference supply node 62; and a coupling circuit 116 which controls the coupling of the low-side switch LS, in embodiments the gate terminal of the respective NMOS transistor 63, to the supply node 111.

In the embodiment of FIG. 2, the coupling circuit 115 comprises an output stage 117 arranged between the nodes 110 and 62 and formed in this embodiment by a PMOS transistor M_{P1} and an NMOS transistor M_{N1}. In embodiments, the output stage 117 may be an inverter (wherein the transistors M_{P1} and M_{N1} have the gate terminals connected and controlled by the same signal); or, the transistors M_{P1} and M_{N1} may be controlled by two different signals generated by a dedicated logic configured to avoid cross-conduction conditions between the two transistors. The output stage 117 may be driven by a low-side buffer 118, as a function of the low-side control signal LS_PWM.

The low-side driver 91 may also control the closing of the low-side switch LS as a function of a sensing signal indicating that the closing of the switch 78 has occurred, which is controlled in response to the voltage V_{SW} at the phase node SW, which has fallen below a threshold. In detail, in the embodiment of FIG. 2, the low-side buffer 118 also receives at input a signal BOOT_SW_ON, provided by the bootstrap control circuit 79.

The coupling circuit 116 comprises a switch, here an NMOS transistor M_{N3}, arranged between the supply node 111 and the output 113 of the low-side driver 91, whose switching is controlled as a function of one or more signals, hereinafter referred to as signal M_ON, which may be indicative of a turning on command of the low-side switch LS or of a signal which indicates that the voltage V_{SW} at the phase node SW has fallen below the respective threshold value.

According to an embodiment, the coupling circuit 116 closes the switch M_{N3} when the signal LS_PWM or the signal LS_OFF indicates the turning on of the low-side switch LS (for example, LS_PWM=‘1’ or LS_OFF=‘0’) and in response to the voltage V_{SW} falling below the respective threshold. For example, the signal indicating that the voltage VSW has fallen below the respective threshold may be SW_SENSE, BOOT_PWM, or another signal, depending on the specific implementation.

In the embodiment of FIG. 2, the coupling circuit 116 comprises a logic circuit 119 that regulates the turning on and turning off of the transistor M_{N3}, as a function of the signal M_ON. According to an embodiment, the logic circuit 119 may also implement a delay (or watchdog) function to control, with a predefined delay, the turning on of the transistor M_{N3} regardless of the trend of the voltage V_{SW} at the phase node. This may be useful to ensure the turning on of the low-side transistor 63 even in the event of a low current through the load 53 or in the event of an inversion of the load current; in fact, in such scenarios, the voltage V_{SW} at the phase node SW may take too long before falling below the threshold value or may not reach below the threshold at all. In the embodiment of FIG. 2, the coupling circuit 116 comprises a buffer BUFF₁ which receives the second regulated signal SW_SENSE and, in response, drives the switching of the transistor M_{N3}.

In use, the high-side driver 90 controls the closing of the high-side switch HS in response to the reception of an event of the high-side control signal HS_PWM, which indicates the closing of the high-side switch HS (for example, a rising or falling edge of the high-side control signal HS_PWM).

To close the high-side switch HS, the high-side driver 90 couples the respective output 98 to the supply node 94; in this manner, at least part of the current required to turn on the NMOS transistor 58 is supplied directly by the input node 51 at the input voltage V_{IN}. This allows for achieving high driving performance of the driving circuit 57 and, in embodiments, for achieving high efficiency in closing the high-side switch HS.

In detail, in a first step of the turning on of the NMOS transistor 58, i.e., as long as the voltage V_{boot} at the bootstrap node BOOT is lower than the input voltage V_{IN}, the high-side driver 90 couples the respective output 98 to the supply node 94, in embodiments by closing the switches M_{N5}, M_{N6}, and decouples the respective output 98 from both the supply node 92 and the reference supply node 93. When the voltage V_{boot} at the bootstrap node BOOT exceeds the input voltage V_{IN}, then the high-side driver 90 couples the respective output 98 to the supply node 92, decouples the respective output 98 from the supply node 94 (in embodiments by opening the switches M_{N5}, M_{N6}), and decouples the respective output 98 from the reference supply node 93. In practice, the high-side driver 90 is configured to use not only the voltage V_{boot} at the bootstrap node BOOT to turn on the NMOS transistor 58, but also the input voltage V_{IN}.

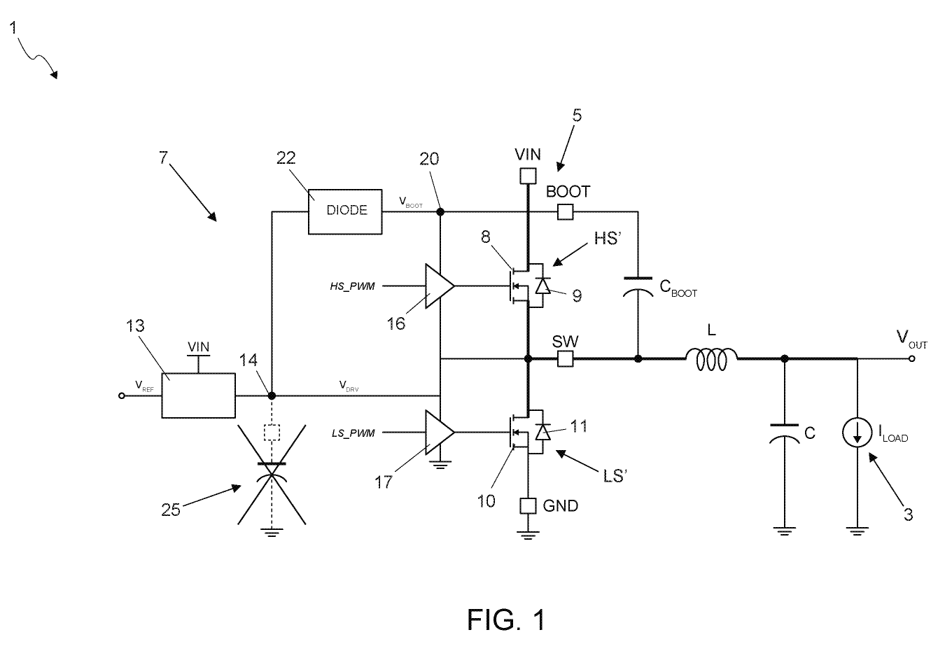

This allows, for example, compared to the known driving circuit 7 of FIG. 1, to discharge the bootstrap capacitor 72 less, thereby reducing the current that the driving voltage regulator 75 needs to provide to charge the bootstrap capacitor 72. Furthermore, this allows the use of a smaller bootstrap capacitor 72, thus reducing the overall size of the converter 50.

In use, the low-side driver 91 controls the closing of the low-side switch LS in response to the reception of an event of the low-side control signal LS_PWM, which indicates the closing of the low-side switch LS (for example, a rising or falling edge of the low-side control signal LS_PWM).

To close the low-side switch LS, the low-side driver 91 couples the respective output 113 to the supply node 111; in this manner, at least part of the current necessary to turn on the NMOS transistor 63 is provided directly by the input node 51, which is at the input voltage V_{IN}.

This allows for achieving high driving performance of the driving circuit 57 and, in embodiments, for achieving high efficiency in closing the low-side switch LS. To close the low-side switch LS, the low-side driver 91 couples the respective output node 113 both to the supply node 110 and the supply node 111. In practice, the low-side driver 91 is configured to use not only the driving voltage V_{DRV} to turn on the NMOS transistor 58, but also the input voltage V_{IN}.

This allows the driving voltage regulator 75, compared to the known driving circuit 7 of FIG. 1, to provide less current at the output to turn on the NMOS transistor 63 of the low-side switch LS. Therefore, the driving voltage V_{DRV} provided by the driving voltage regulator 75 exhibits low fluctuations. The driving circuit 57 has high reliability and, therefore, high driving performance of the switching circuit 55.

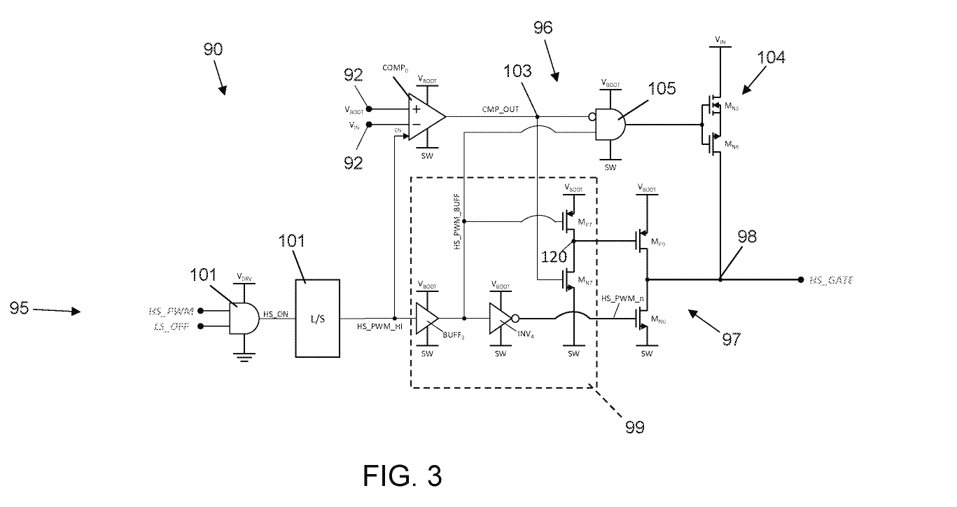

FIG. 3 shows a detailed embodiment of the high-side driver 90 of FIG. 2. The logic 105 is formed, in this embodiment, by an AND logic gate, in embodiments supplied between the voltage V_{boot} at the bootstrap node BOOT and the voltage V_{SW} at the phase node SW, which receives at a first input the signal CMP_OUT, negated, provided by the comparator COMP₀, and at a second input a signal HS_PWM_BUFF provided by the high-side buffer 99. The high-side buffer 99 receives at its input a signal HS_PWM_HI from the level shifter circuit 101.

For example, the signal HS_PWM_HI may have a high logic value when the signal HS_ON also has a high logic value, i.e., when the high-side control signal HS_PWM indicates the closing of the high-side switch HS and when the signal LS_OFF indicates the opening of the low-side switch LS. The HS_PWM_HI signal may also serve as the activation signal EN for the comparator COMP0.

The high-side buffer 99 comprises one or more driving adapting circuits, here a buffer BUFF₂ and an inverter INV₄ cascaded to each other, which control the switching of the NMOS transistor M_{N0} of the output stage 97; and a logic circuit, formed here by a PMOS transistor M_{P7} and an NMOS transistor M_{N7}, which controls the switching of the PMOS transistor M_{P0} of the output stage 97. The gate terminal of the NMOS transistor M_{N0} is coupled to an intermediate node 120 of the high-side driver 99, between the PMOS transistor M_{P7} and the NMOS transistor M_{N7}.

The PMOS transistor M_{P7} of the high-side buffer 99 is driven by the signal HS_PWM_BUFF provided at the output by the buffer BUFF₂. The NMOS transistor M_{N7} of the high-side buffer 99 is driven by the signal CMP_OUT provided at the output by the comparator COMP₀.

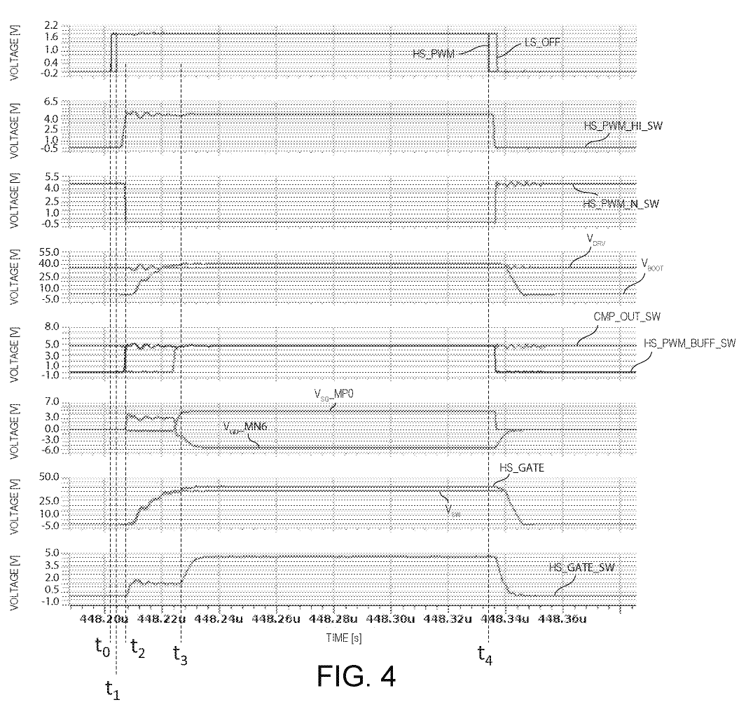

FIG. 4 shows an example of waveforms of the driving circuit 57 of FIG. 2, in use, during a closing step of the high-side switch HS. In embodiments, FIG. 4 shows waveforms associated with the operation of the high-side driver 90 for closing the high-side switch HS. The closing of the high-side switch HS begins at an event (instant t₀) of the high-side control signal HS_PWM, in embodiments here a rising edge.

In response, the signal LS_OFF also has a rising edge (instant t₁), with a delay with respect to instant t₀ which depends on the specific implementation, in embodiments of the low-side buffer 118, and in response (instant t₂) the signals HS_PWM_HI_SW (corresponding to HS_PWM_HI – V_{SW}, i.e., the signal HS_PWM_HI referred to the phase node SW) and therefore the respective negated signal HS_PWM_n_SW (i.e., the signal HS_PWM_n_SW referred to the phase node SW) also switch.

The signal HS_PWM_n is kept low during the closing of the high-side switch HS; therefore, during the closing of the high-side switch HS, the coupling circuit 95 keeps the output 98 decoupled from the reference node 93.

In practice, in the period preceding the instant t₂, the enabling signal of the comparator COMP₀, which is connected to the signal HS_PWM_HI, is at the low value. The comparator COMP₀ is designed to return a high logic value regardless of the other inputs when EN is at a low value. For such reason, the signal CMP_OUT_SW (i.e., the signal CMP_OUT referred to the phase node SW) at the output of the comparator COMP₀ has a high logic value until the instant t₂.

At the instant t₂, the signal HS_PWM_HI goes to the high logic level, enabling the comparator COMP₀; thereafter, the output signal CMP_OUT will depend on the two input voltages V_{IN} and V_{BOOT}.

In the general hypothesis that V_{IN}>V_{DRV}, at the instant t₂, the input voltage V_{IN} is higher than the boot voltage V_{boot} at the bootstrap node BOOT, so the signal CMP_OUT_SW (i.e., the signal CMP_OUT referred to the phase node SW) at the output of the comparator COMP₀ goes to the low logic value.

Therefore, at the instant t₂, in response to the switching of the signal HS_PWM_BUFF to the high logic value, the signal at the gate terminal of the switches M_{N5} and M_{N6} of the coupling circuit 104 also has a rising edge (signal VGD_MN6 in FIG. 4).

Consequently, after the instant t₂, the voltage HS_GATE at the gate terminal of the NMOS transistor 58 of the high-side switch HS rises with respect to the voltage V_{SW} at the phase node SW (signal HS_GATE_SW of FIG. 4).

Following the turning on of the NMOS transistor 58, the voltage at the phase node SW begins to rise; in response, the voltage V_{boot} at the bootstrap node BOOT, coupled to the phase node SW through the bootstrap capacitance C_{BOOT} 72, also increases until it becomes equal (instant t₃) to the input voltage V_{IN}.

At the instant t₂, the switch M_{P7}, driven by the HS_PWM_BUFF signal, opens. Furthermore, between the instant t₂ and the instant t₃, the switch M_{N7}, which is driven by the signal CMP_OUT, remains open; therefore, the switch M_{P0} of the output stage 97 remains open (signal Vsg_MP0 of FIG. 4 indicating the source-gate voltage of the transistor M_{P0}).

At the instant t₃, when the boot voltage V_{boot} reaches the input voltage V_{IN}, the signal CMP_OUT provided by the comparator COMP₀ switches to the low logic value, thus causing both the opening of the switches M_{N5}, M_{N6} of the coupling circuit 104 and the closing of the switch M_{P0} of the output stage 97.

In practice, the coupling circuit 96 decouples the output 98 from the input voltage V_{IN} and the coupling circuit 96 couples the output 98 to the boot voltage V_{boot}. Therefore, in response to the instant t₃, the signal HS_GATE_SW continues to rise and the high-side driver 90 finishes the closing step of the high-side switch HS by using the boot voltage V_{boot}. The high-side driver 90 then keeps the high-side switch HS closed for the entire duration indicated by the high-side control signal HS_PWM; i.e., here until the falling edge of the signal HS_PWM at the instant t₄, wherein the opening step of the high-side switch HS begins.

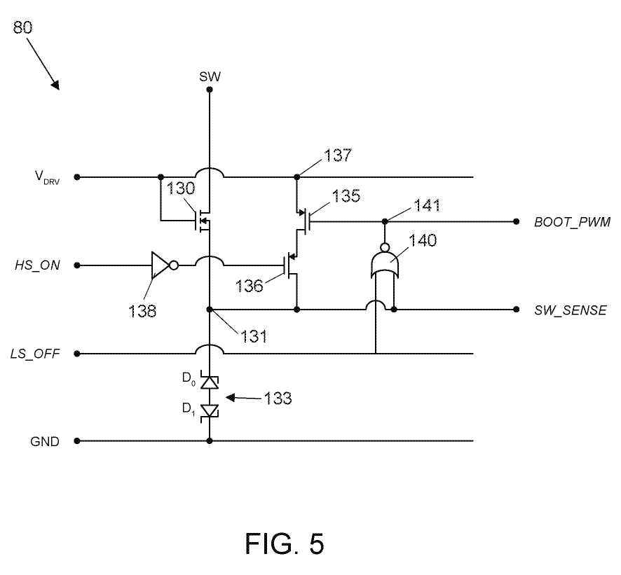

FIG. 5 shows a detailed embodiment of the sensing circuit 80. The sensing circuit 80 comprises a switch, in embodiments an NMOS transistor 130, arranged between the phase node SW and an internal node 131 and driven by the driving voltage V_{DRV}. A pair of Zener diodes 133 in a back-to-back configuration may be arranged between the internal node 131 and ground GND. A series circuit, formed by two PMOS transistors 135, 136, is arranged between a supply node 137, which is coupled to the driving voltage V_{DRV}, and the internal node 131. The NMOS transistor 136 is driven by an inverter 138, which receives at its input the logic signal HS_ON. A logic gate 140, here of the NOR type, has a first input at which it receives the logic signal LS_OFF and a second input coupled to the internal node 131. The logic gate 140 has an output 141 coupled to the gate terminal of the PMOS transistor 135. The first regulated signal BOOT_PWM provided at the output by the sensing circuit 80 corresponds to the signal at the output node 141 of the logic gate 140. The second regulated signal SW_SENSE provided at the output by the sensing circuit 80 corresponds to the signal at the internal node 131. However, it will be clear to the person skilled in the art that the sensing circuit 80 may be implemented in a manner other than that shown. For example, it may have a different number of switches, logic gates, etc., depending on the specific application and implementation.

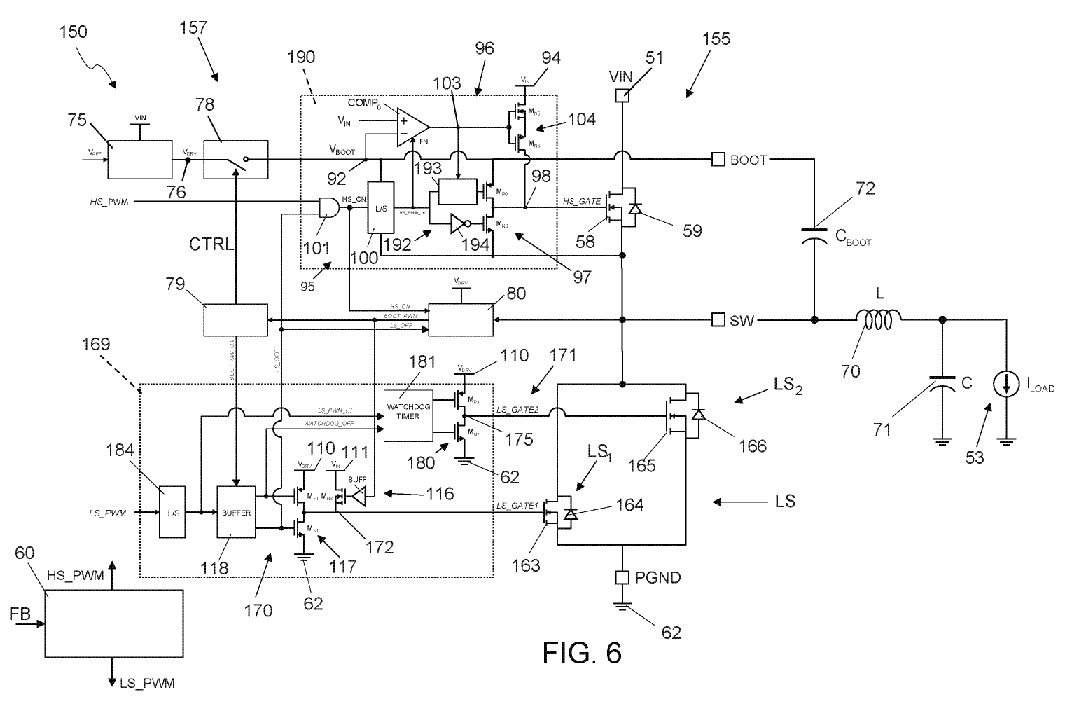

FIG. 6 shows a different embodiment of the voltage converter, indicated as 150. The converter 150 has a general structure similar to that of the converter 50 of FIG. 2; therefore, elements in common are indicated by the same reference numbers and are not further described in detail. The voltage converter 150 comprises a switching circuit, in embodiments a half-bridge circuit 155, and a driving circuit 157.

Unlike the half-bridge circuit 55 of FIG. 2, the half-bridge circuit 155 comprises a low-side switch circuit LS’’ including a parallel circuit having a first low-side switch LS₁ in a first circuit branch and a second low-side switch LS₂ in a second circuit branch parallel to the first circuit branch.

The first low-side switch LS₁ is formed, in the embodiment shown, by an NMOS transistor 163 and may comprise a parasitic diode 164 associated with the NMOS transistor 163. The second low-side switch LS₂ is formed, in the embodiment shown, by an NMOS transistor 165 and may comprise a parasitic diode 166 associated with the NMOS transistor 165. The first low-side switch LS₁ is configured to allow the flowing of a lower current than the second low-side switch LS₂. In embodiments, in the embodiment shown, the NMOS transistor 163 is configured, in the on-state, to allow the flow of a current, and the NMOS transistor 165 is configured, in the on-state, to allow the flow of a current that is higher than the current of the NMOS transistor 163.

In detail, according to an embodiment, the first and the second low-side switches LS₁, LS₂ may be configured such that, in the presence of a maximum current load I_{L,max} which flows in the inductor I_{L} and when the first low-side switch LS₁ is closed (NMOS transistor 163 on) and the second low-side switch LS₂ is open (NMOS transistor 165 off), the source-drain voltage of the NMOS transistor 163 (i.e., R_{DS,on}∙I_{L,max}) is lower than the threshold voltage of the diode 166 of the second low-side switch LS₂; this allows to avoid a recirculation current on the diode 166.

This may be achieved, for example, by appropriately sizing the transistors 163, 165 and in embodiments by appropriately regulating (during the design step) the ratio thereof.

For example, the NMOS transistor 163 may be sized in such a way as to allow the flow of a lower current than the NMOS transistor 165. For example, the length of the NMOS transistor 163 may be shorter than the length of the NMOS transistor 165.

The low-side driver, indicated by 169 in FIG. 6, therefore comprises a first branch 170 configured to control the opening or closing of the first low-side switch LS₁, and a second branch 171 configured to control the opening or closing of the second low-side switch LS₂.

The first branch 170 of the low-side driver 169 forms a first output 172 of the low-side driver 169 and comprises, as described for the low-side driver 91 of FIG. 2, the buffer 118 and the coupling circuits 116, 117. The first output 172 is coupled to the gate terminal of the NMOS transistor 163 of the first low-side switch LS₁.

The second branch 171 of the low-side driver 169 forms a second output 175 of the low-side driver 169, which is coupled to the gate terminal of the NMOS transistor 165 of the second low-side switch LS₂. In detail, the second branch 171 of the low-side driver 169 is configured to control the closing of the second low-side switch LS₂ with a delay ∆T that is independent of the sensing signal SW_SENSE. In embodiments, the delay ∆T may exceed the switching time of the bootstrap switch circuit 78 between the open and closed states.

In practice, the second branch 171 is configured to introduce a deadtime (i.e., the delay ∆T) during the closing of the second low-side switch LS₂ (i.e., the NMOS transistor 165 turning on). In embodiments, the second branch 171 introduces a fixed deadtime in the turning on of the NMOS transistor 165, that is regardless of the trend of the voltage V_{SW} at the phase node SW. The delay ∆T may be, for example, of the order of tens of nanoseconds, and, in embodiments, ranging from 10 ns to 90 ns. According to an embodiment, the delay ∆T may be chosen in such a way as to be negligible compared to the minimum T_{off} of the switching circuit 55. This may ensure a correct operation of the converter 50. According to an embodiment, the delay ∆T may be chosen such that, below a threshold value (for example of a few tens of mA, in embodiments about 10 mA) of the output load current I_{load}, the delay ∆T is lower than the adaptive deadtime introduced by the first branch 170; therefore, in this scenario, the second low-side switch LS₂ closes before the first low-side switch LS₁. On the contrary, above the threshold value of the output load current I_{load}, the delay ∆T is higher than the adaptive deadtime introduced by the first branch 170; therefore, in this scenario, the second low-side switch LS₂ closes after the first low-side switch LS₁.

In embodiments, the low-side driver 169 may be configured to introduce the delay ∆T with respect to the reception of an event of the low-side control signal LS_PWM (for example, a respective rising edge) which indicates the closing of the low-side switch circuit LS. In embodiments, the delay ∆T may be fixed during the use of the voltage converter 150, i.e., it may be decided during the design or calibration step of the voltage converter 150 by a user. In other words, the second branch 171 of the low-side driver 169 controls the closing of the second low-side switch LS₂ regardless of the trend of the voltage V_{SW} at the phase node SW.

The low-side driver 169 comprises, in the second branch 171, an output stage 180 which is configured to couple the second output 175 to the supply node 110 (i.e., to the driving voltage V_{DRV}) or the reference supply node (ground 62); and a delay circuit (also called “watchdog timer”) 181 which drives the output stage 180 with the delay ∆T with respect to the event of the low-side control signal LS_PWM which indicates the closing of the low-side switch LS.

In embodiments, the delay circuit 181 may be configured to introduce the delay ∆T only during the closing step of the low-side switch LS, and not during its opening step. The delay circuit 181 may also comprise a buffer for driving the output stage 180. In more detail, the output stage 180 comprises a PMOS transistor M_{P2} and an NMOS transistor M_{N2,} which are driven by the delay circuit 181.

The low-side driver 169 may also comprise a level shifter circuit 184, which has an input for receiving the low-side control signal LS_PWM and an output coupled to the buffer 118.

The high-side driver of the driving circuit 157, indicated by 190 in FIG. 6, also comprises the coupling circuits 95, 96, as described with reference to FIGS. 2 and 3.

Unlike the high-side driver 90, the high-side driver 190 does not comprise the logic 105 in the coupling circuit 96, while the buffer 192 of the coupling circuit 95 comprises a circuit 193 which introduces a delay in the closing of the transistor M_{P0}, as a function of the signal COMP_OUT output by the comparator COMP₀, and an inverter 194 which drives the transistor M_{N0}. In embodiments, the logic 105 is not provided in the coupling circuit 96 since its function is integrated into the comparator COMP₀. This is done by inverting the two inputs of the comparator COMP₀ through an enable signal, which keeps the output of the comparator COMP₀ at 0 if HS_PWM_BUFF = 0.

The driving circuit 157, with regard to the switching (in embodiments, the closing) of the high-side switch circuit HS, operates similarly to the driving circuit 57 described above. The fact that the low-side switch circuit LS’’ is formed by two switches, along with the fact that the driving circuit 157 controls the switching (in embodiments, the closing) of the second low-side switch LS₂, regardless of the trend of the voltage V_{SW} at the phase node SW, may allow the switching efficiency of the low-side switch circuit LS’’ to be further increased.

FIG. 7 shows a detailed embodiment of a possible implementation of the low-side driver 169 of the driving circuit 157. With reference to FIG. 7, the low-side driver 169 may also comprise an inverter INV₀, arranged at the output of the level shifter circuit 184, which provides a negated signal LS_PWM_HI_n indicative of the closing or opening of the low-side switch LS’’.

In the detailed implementation of FIG. 7, in the branch 170, which drives the first low-side switch LS1, the buffer 118 comprises an upper branch 201, which drives the PMOS transistor MP1 of the output stage 117, and a lower branch 202, which drives the NMOS transistor M_{N1} of the output stage 117.

To turn on the first low-side switch LS₁, the control signal LS_PWM is brought from ‘0’ to ‘1’ by the switching control circuit 60 (FIG. 6). This causes that in the lower branch 202, at the gate terminal of the transistor M_{N1} there is a ‘0’ which causes the transistor M_{N1} to turn off. The signal LS_OFF, which goes from ‘1’ to ‘0’, enables the NOR gate 140 arranged in the circuit 80 of FIG. 5. The signal BOOT_PWM, therefore, is now able to indicate the fall in the voltage V_{SW} of the phase node SW below the set threshold. Until that moment, BOOT_PWM remains at ‘0’; in response to the voltage V_{SW} crossing the threshold, the signal BOOT_PWM will switch to ‘1’. As long as BOOT_PWM = ‘0’, the feedback signal of the circuit 79 is also BOOT_SW_ON = ‘0’. This entails that in the upper branch 201, at the gate terminal of the transistor M_{P1}, a logic ‘1’ remains, which keeps the transistor M_{P1} off. Therefore, the output stage 117 remains in the high impedance state. Only when the switch 78 closes (FIG. 6), which occurs due to BOOT_PWM going from ‘0’ to ‘1’, the upper branch 201 changes state, thus allowing the closing of the transistor M_{P1}.

In detail, in the embodiment of FIG. 7, the upper branch 201 comprises a NOR logic gate, indicated by NOR₀, which receives the signal LS_PWM_HI_n at a first input and the signal BOOT_SW_ON at a second negated input. It provides a signal WATCHDOG_OFF, and an inverter INV₁ whose input is coupled to the output of the logic gate NOR₀. The lower branch 202 comprises a NAND logic gate, indicated by NAND₀, which receives the signal LS_PWM_HI_n at a first input and has a second input coupled to the output of the inverter INV₁ of the upper branch 201, and an inverter INV₂ whose input is coupled to the output of the logic gate NAND₀.

In the embodiment of FIG. 7, the delay circuit 181 comprises a capacitor C₀, arranged between the supply node 110 at the driving voltage V_{DRV} and a node 205, and a resistor R₀, arranged between the node 205 and a node 206; the capacitor C₀ and the resistor R₀ set the delay ∆T introduced by the delay circuit 181 in the closing of the second low-side switch LS₂.

The node 205 is coupled to the gate terminal of the PMOS transistor M_{P2} of the output stage 180; the node 206 is coupled to the gate terminal of the NMOS transistor M_{N2} of the output stage 180.

The delay circuit 181 further comprises a circuit 208 including a PMOS transistor M_{P4}, arranged between the driving voltage V_{DRV} and the node 205, and an NMOS transistor M_{N4}, arranged between the node 205 and the ground 62.

The delay circuit 181 further comprises an inverter INV₃, which receives the signal LS_PWM_HI_n and whose output drives the PMOS transistor MP4, and a buffer BUFF1, which receives the signal LS_PWM_HI_n and whose output is coupled to the node 206.

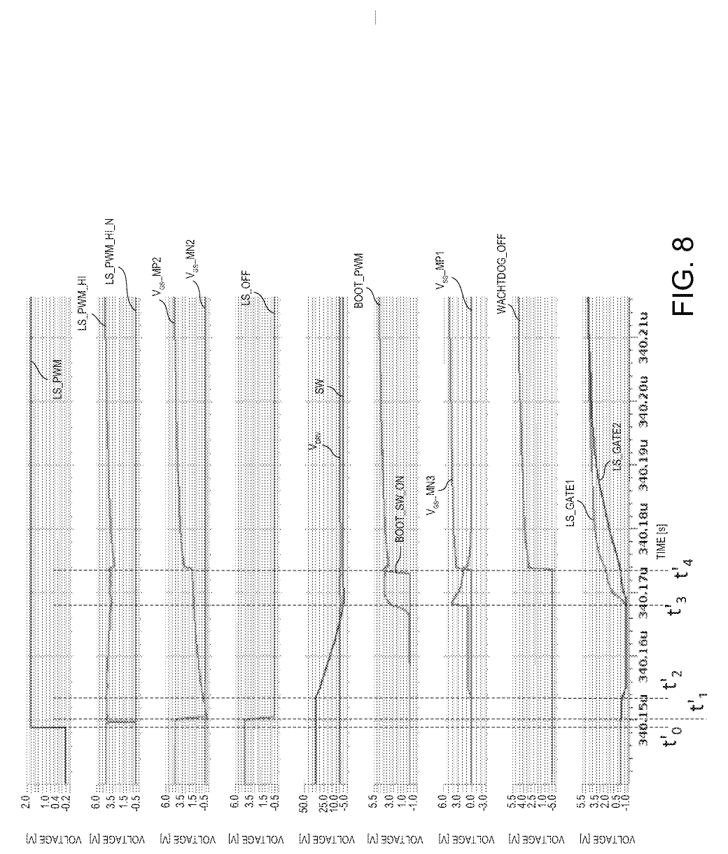

FIG. 8 shows an example of waveforms of the driving circuit 157 of FIG. 6, in use, during a closing step of the low-side switch LS’’. In embodiments, FIG. 8 shows waveforms associated with the operation of the low-side driver 169 for closing the low-side switch LS’’. In detail, FIG. 8 shows an example of the trend of the following signals: low-side control signal LS_PWM, signals LS_PWM_HI and LS_PWM_HI_n, gate-source signal of the NMOS transistor M_{N2} (Vgs_MN2) and source-gate signal of the PMOS transistor M_{N2} (Vsg_MP2), signal LS_OFF, driving voltage V_{DRV}, voltage V_{SW} at the phase node SW, signals BOOT_PWM and BOOT_SW_ON, gate-source signal of the NMOS transistor M_{N3} (Vgs_MN3) and source-gate signal of the PMOS transistor M_{N1} (Vsg_MP1), signal WATCHDOG_OFF, control signal LS_GATE1 of the first low-side switch LS₁ and control signal LS_GATE2 of the second low-side switch LS₂.

The closing of the low-side switch LS’’ begins at an event (instant t’₀) of the low-side control signal LS_PWM, in embodiments here a rising edge. In response to the switching of the low-side control signal LS_PWM, the signals LS_PWM_HI and LS_PWM_HI_n also switch (instant t’₁) and therefore consequently the NMOS transistor M_{N2} turns-off and the voltage at the gate terminal of the PMOS transistor M_{P2} begins to fall with a time constant R₀C₀ introduced by the delay circuit 181 until the instant t’₄ wherein the signal WATCHDOG_OFF switches to the high logic value, thus causing the turning on of the NMOS transistor M_{N4} and, consequently, the complete turning on of the PMOS transistor M_{P2}.

Meanwhile, in response to the switching of the low-side control signal LS_PWM, the signal LS_OFF also has a falling edge (instant t’₁), with a delay with respect to the instant t’₀ which depends on the specific implementation of the low-side driver 169, in embodiments of the buffer circuit 118.

Although not shown here, along with switching the low-side control signal LS_PWM to the high logic value, the circuit 60 also switches the high-side control signal HS_PWM to the low logic value to open it.

In response to the opening of the high-side switch HS, instant t’₂, the voltage V_{SW} at the phase node SW begins to decrease, for example, due to the current drawn by the load 53.

In response to sensing that the voltage V_{SW} at the phase node SW has fallen below the threshold (instant t’₃), the sensing circuit 80 switches the regulated signal BOOT_PWM to the high value and with it also the control signal Vgs_MN3, causing the turning on of the NMOS transistor M_{N3} of the coupling circuit 116.

In response, the output 172 of the low-side driver 169 is coupled to the input voltage V_{IN}; consequently, the control signal LS_GATE1 begins to rise and therefore the turning on of the NMOS transistor 163 begins.

The coupling of the control signal LS_GATE1 to the input voltage V_{IN} is maintained until the voltage VGS_MN3 = V_{DRV} - LS_GATE1 is higher than the threshold voltage of the NMOS transistor M_{N3}. When the threshold is exceeded, MN3 will naturally turn off.

In response to the switching (instant t’₃) of the signal BOOT_SW_ON, the bootstrap control circuit 79 carries out the turning on of the switch 78, which therefore puts in connection the internal supply node V_{DRV} 76 to the external capacitance C_{BOOT} 72. In response to this event, the bootstrap control circuit 79 carries out the switching of the feedback signal BOOT_SW_ON from ‘0’ to ‘1’ (instant t’₄) with a delay depending on the embodiment’s implementation of the circuit. At the switching of the signal BOOT_SW_ON, the PMOS transistor M_{P1} turns on. In practice, at the instant t’₄, the low-side driver 169 couples the respective output 172 to the driving voltage V_{DRV} (by virtue of the turning on of the PMOS transistor M_{P1}). Meanwhile, due to the NMOS transistor MN3 turning off naturally, the NMOS transistor MN3 decouples the output 172 from the input voltage VIN.

In practice, the closing of the low-side switch LS’’ is performed partly by coupling the low-side switch LS’’ to the driving voltage V_{DRV} and partly by coupling the low-side switch LS’’ to the input voltage V_{IN}. This allows reducing the current required at the output by the driving voltage regulator 75 and reducing the oscillations of the driving voltage V_{DRV}.

In embodiments, the input voltage V_{IN} may be used in an initial step of the closing of the low-side switch LS’’; while the driving voltage V_{DRV} may be used in a final step of the closing of the low-side switch LS”, which is temporally after the initial step.

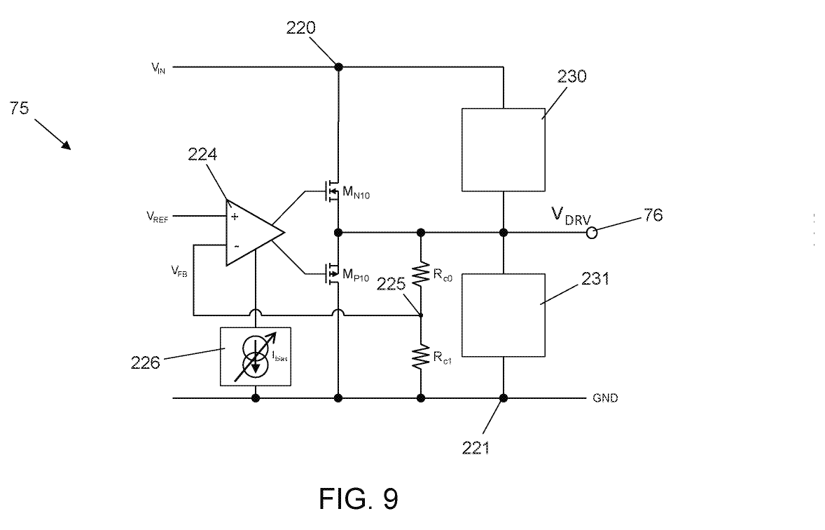

FIG. 9 shows a detailed embodiment of a possible implementation of the driving voltage regulator 75 of the driving circuit 57 or 157. The driving voltage regulator 75 has a supply node 220 at the input voltage V_{IN} and a reference supply node 221 at the ground GND, for example, coupled to the node PGND of FIGS. 2 and 6.

The driving voltage regulator 75 comprises an operational amplifier 224, which receives at a first input the reference voltage VREF and, at a second input, which is coupled to an internal node 225, an internal feedback voltage V_{FB}. The operational amplifier 224 has an adaptive supply source 226, which is configured to provide a supply current I_{bias} of the operational amplifier 224.

The adaptive supply source 226 is configured to increase the supply current I_{bias} in proportion to the load 53 of the regulator 75 and to fluctuations in the regulated output voltage V_{DRV}. However, in general, the adaptive supply source 226 may be configured to increase or decrease the supply current I_{bias} as a function of an activation threshold indicative of the difference between the driving voltage V_{DRV} and the desired set-point value.

The adaptive supply source 226, therefore, allows for an adaptive increase in the bandwidth of the regulator 75 and, therefore, quickly compensates for large deviations of the driving voltage V_{DRV}.

The regulator 75 further comprises a switch, here an NMOS transistor M_{N10}, arranged between the supply node 220 and the driving output 76, and a switch, here a transistor M_{P10}, arranged between the driving output 76 and the ground node 221. The transistors M_{N10} and MP10 are driven by the respective output signals of the operational amplifier 224.

The driving voltage regulator 75 comprises a voltage divider circuit, arranged between the output 76 and the ground 221, which provides the feedback voltage V_{FB} and is formed in this embodiment by a pair of resistors R_{c0}, R_{c1}.

The regulator 75 comprises a low clamp circuit 230, arranged between the supply node 220 and the output 76, configured to eliminate undershoots in the driving voltage V_{DRV} below the desired nominal value. In practice, the low clamp circuit 230 is configured to ensure that a (negative) difference between the driving voltage V_{DRV} and the desired nominal voltage is kept lower than a low threshold. The regulator 75 also comprises a high clamp circuit 231, arranged between the output 76 and the ground node 221, configured to limit overshoots of the driving voltage V_{DRV} above the desired nominal value.

In practice, the high clamp circuit 231 is configured to ensure that the (positive) difference between the driving voltage VDRV and the desired nominal voltage is kept below a high threshold.

The high threshold of the high clamp circuit 231 and the low threshold of the low clamp circuit 230 may be equal or different, depending on the specific application. For example, the thresholds may be designed so as to ensure that any overshoots of the driving voltage V_{DRV} does not damage the circuitry of the low-side or high-side drivers and that any overshoots of the driving voltage V_{DRV} ensure the correct operation of the driven circuits.

The presence of the clamp circuits 230, 231 allows the reduction of oscillations in the driving voltage V_{DRV} around the desired value. Therefore, the driving circuits 57 and 157 may exhibit high driving performance.

It will be clear to the person skilled in the art that the regulator 75 may be designed in such a way as to have only one or more of: the adaptive supply circuit 226, the low clamp circuit 230 and the high clamp circuit 231.

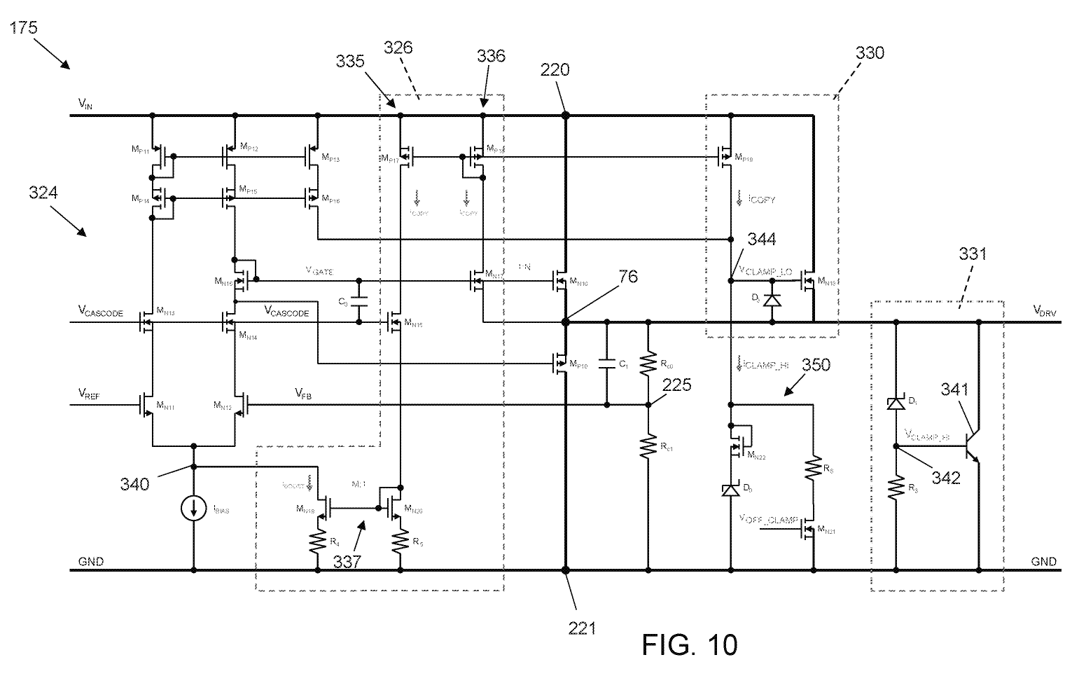

FIG. 10 shows a detailed embodiment of a possible implementation of the driving voltage regulator of FIG. 9, here indicated by 175. The operational amplifier, here indicated by 324, is formed by a plurality of PMOS transistors, indicated in FIG. 10 by M_{P11}, M_{P12}, M_{P13}, M_{P14}, M_{P15}, M_{P16}, and a plurality of NMOS transistors, indicated in FIG. 10 by M_{N11}, M_{N12}, M_{N13}, M_{N14}, M_{N16}, which are arranged in a configuration known per se and therefore not further discussed in detail.

In embodiments, the NMOS transistors M_{N11}, M_{N12} are driven by the reference voltage V_{REF} and, respectively, by the feedback voltage V_{FB}, and therefore form the input stage of the operational amplifier 324.

The PMOS transistors M_{P11}, M_{P12}, M_{P13}, M_{P14}, M_{P15}, M_{P16,} and the NMOS transistors M_{N13}, M_{N14}, M_{N16} are arranged in such a way as to form current mirrors.

The adaptive supply circuit, indicated by 326 in the embodiment of FIG. 10, comprises a circuit branch 335 and a circuit branch 336 configured to allow, in use, the flowing of the same current I_{COPY}. The circuit branch 335 extends from the supply node 220 to the ground node 221, the circuit branch 336 extends from the supply node 336 to the output 76.

In detail, in the embodiment of FIG. 10, the circuit branch 335 is formed by a series circuit comprising a PMOS transistor M_{P17}, an NMOS transistor M_{N15} and an NMOS transistor M_{N20}, and the circuit branch 336 is formed by a series circuit comprising a PMOS transistor M_{P18} and an NMOS transistor M_{N17}.

The gate terminal of the NMOS transistor M_{N17} is at the same voltage V_{GATE} as the NMOS transistor M_{N16} of the operational amplifier 324 and the output NMOS transistor M_{N10}. Furthermore, the NMOS transistor M_{N17} is configured so as to have a current ratio 1:N with respect to the NMOS transistor M_{N10}.

The gate terminal of the NMOS transistor M_{N15} is at the same voltage as the NMOS transistor M_{N14} of the operational amplifier 324.

A capacitor C₀ is coupled between the gate terminals of the NMOS transistors M_{N15} and M_{N17}.

The adaptive supply circuit 326 also comprises a current mirror 337 having a first portion in the circuit branch 335, comprising the NMOS transistor M_{N20}, and a second portion arranged between an internal node 340 of the operational amplifier 324 and the ground 221 and comprising the NMOS transistor M_{N19}.

The current mirror 337 has a ratio M:1 between the current I_{BOOST}, which flows through the NMOS transistor MN19, and the current ICOPY, which flows in the circuit branch 335, such that the current I_{BOOST} is higher than or equal to the current I_{COPY}.

The adaptive supply circuit 326 may also comprise a resistor R₄, in series with the NMOS transistor M_{N19}, or a resistor R₅, in series with the NMOS transistor M_{N20}. The resistors R₄, R₅ allow for avoiding any instability if the driving voltage VDRV reaches a voltage value that is too low.

The high clamp circuit 331 comprises a switch 341, in embodiments a bipolar transistor, between the output 76 and the ground node 221, and a driving circuit of the switch 341 arranged in parallel with the switch 341 and configured to close the switch 341 when the driving voltage V_{DRV} rises above a threshold.

In detail, the driving circuit of the switch 341 comprises a Zener diode D₁ in series with a resistor R₃.

The voltage V_{CLAMP_HI} at the intermediate node 342 between the Zener diode D₁ and the resistor R₃ controls the switching of the switch 341. In embodiments, in this case, the threshold is determined by the sum of the Zener voltage and the voltage V_{BE}, for example, equal to about 5.5 V.

By regulating the electrical characteristics of the driving circuit of the switch 341, in embodiments here the electrical characteristics of the Zener diode D₁ and the resistor R₃, the high threshold of the high clamp circuit 331 may be modified.

The low clamp circuit 330 comprises a switch, in embodiments an NMOS transistor M_{N18}, arranged between the supply node 220 and the output 76; a diode D₃ is arranged between the output 76 and a node 344 having the gate terminal of the transistor M_{N18} coupled thereto.

The node 344 is at a voltage V_{CLAMP_LO,} which controls the switching of the transistor M_{N18}.

In the embodiment of FIG. 10, the low clamp circuit 330 also comprises a current mirror, which causes the current I_{COPY} to flow from the supply node 220 to the node 344; in embodiments, the current mirror comprises a PMOS transistor M_{P19} having the gate terminal coupled to the gate terminal of the PMOS transistor M_{P18}.

The regulator 175 also comprises a parallel circuit 350 coupled between the node 344 and the ground node 221; the parallel circuit 350 has, in a first branch, a Zener diode D₀ and an NMOS transistor M_{N22} and, in a second branch, an NMOS transistor M_{N21} and a resistor R₆.

The parallel circuit 350 is configured to allow, in use, a current I_{CLAMP_HI} to flow from the node 344 to the ground node 221. In detail, the NMOS transistor MN21 is controlled by a signal VOFF_CLAMP, for example, a pulse, that serves to inhibit the clamp, if necessary, depending on the specific driver characteristics.

In use, the presence of the diode D₃ of the low clamp circuit 330 may ensure a quick return to the set-point of the voltage V_{CLAMP_LO} at the node 344 and therefore a quick turning on, if necessary, of the NMOS transistor M_{N18}.

In embodiments, the NMOS transistor M_{N11} and the diode D₃ allow, when the signal V_{OFF_CLAMP} is high, to create a current path between the driving voltage V_{DRV} and the ground GND; the current subtracted from the driving voltage V_{DRV} allows for quick compensation for the overshoots of the driving voltage V_{DRV} above the desired nominal value.

It will be clear to the person skilled in the art that the operational amplifier 324, the adaptive supply circuit 326, the low clamp circuit 330 and the high clamp circuit 331 may have a circuit diagram different from that described with reference to FIG. 10.

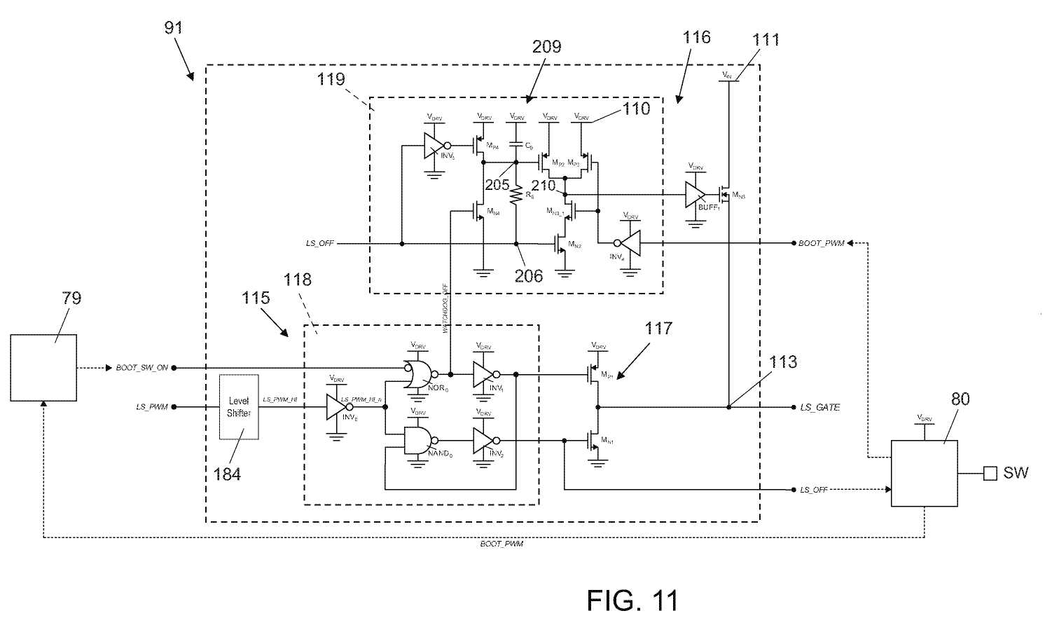

FIG. 11 shows a detailed embodiment of the low-side driver 91 of FIG. 2 and, in embodiments, of the respective logic circuit 119. For the low-side driver 91, a specific implementation of the buffer 118 that drives the output stage 117 is shown. The buffer 118 is the same as the buffer 118 of FIG. 7, whose description is therefore not repeated here in further detail, and whose elements are indicated by the same reference numbers.

In this embodiment, the logic circuit 119 controls the switching of the NMOS transistor M_{N3} as a function of the signal LS_OFF and the signal BOOT_PWM.

In detail, the logic circuit 119 comprises a delay (watchdog) circuit 209, which drives the buffer BUFF₁. The delay circuit 209 has an implementation similar to that of the delay circuit 181 of FIG. 7. Therefore, elements in common are indicated by the same reference numbers, and for the respective description, reference is made to what has already been discussed with regard to the delay circuit of FIG. 7. Unlike the delay circuit 181, the delay circuit 209 comprises an NMOS transistor M_{N3_1} arranged between the series of the transistors M_{N2}, M_{P2}, and a PMOS transistor M_{P3} arranged between the node 110 at the driving voltage V_{DRV} and the transistor M_{N3_1}.

An inverter INV₄ receives at input the signal BOOT_PWM and drives the transistors M_{P3} and M_{N3_1}.

The buffer BUFF₁, which drives the transistor M_{N3}, has an input coupled to an intermediate node 210 of the logic circuit 119 arranged between the transistors M_{P3}, M_{N3_1}.

Finally, modifications and variations may be made to what has been described and illustrated here without thereby departing from the scope of the present disclosure, as defined in the attached claims.

For example, one or both of the bootstrap switch circuit 78 and the bootstrap control circuit 79 may be optional, depending on the specific configuration and application of the driving circuit 57, 157; for example, if the high-side of the switching circuit 55 is not formed by NMOS transistors.

For example, all or some of the switches described with reference to each of the circuits of the voltage converter 50, 150 may be switches made by of electrical elements other than MOS transistors; for example, bipolar transistors or of other type.

For example, the type of transistor (NMOS, PMOS) may be reversed with respect to what has been described and illustrated; in such case, the respective driving circuits and driving signals may be adapted accordingly.

For example, the output circuit of the voltage converters 50, 150, formed in FIGS. 2 and 6 by the capacitors 72, 71 and the inductor 70 may comprise electrical elements other than those shown, depending on the specific application, the specific load 53, etc.

For example, one or more of the bootstrap capacitor 72, the capacitor 71, and the inductor 70 may be discrete or integrated elements depending on the specific application.

In general, the bootstrap capacitor 72 may be a capacitive element having a capacitance C_{BOOT} implemented through a capacitor, that is integrated or discrete, or through a different electrical element or circuit configured to introduce the capacitance C_{BOOT} between the nodes BOOT and SW.

For example, the half-bridge circuit 55 may be a different switching circuit, for example comprising a different number of high-side or low-side switches, depending on the specific application.

In addition or alternatively, the switching circuit may comprise further half-bridge circuits, depending on the specific voltage converter that is indented to be implemented (e.g., buck, boost, buck-boost converters, or other switching voltage converters of known types).

For example, the logic values ‘high’ and ‘low’ may be inverted with respect to what has been discussed above and the respective logic circuits adapted accordingly, in a manner which is clear per se to the person skilled in the art.

For example, the driving circuit discussed here may be used to drive a switching circuit integrated (or incorporated) within an electronic device other than a switching voltage converter. In embodiments, the driving circuit may be used to drive a switching circuit having at least one half-bridge circuit arranged between an input node and a reference potential node, in embodiments comprising two or more NMOS transistors.

In practice, the present driving circuit may be used in all those applications which envisage at least one half-bridge switching circuit, for example motor control circuits, DC-AC converters (inverters), AC-DC converters (rectifiers), etc.

Alternatively, the present driving circuit may also be used to drive switching circuits comprising single high-side or single low-side, such as for example the asynchronous DC-DC converters.

Finally, the different embodiments described above may be combined so as to provide further solutions.

In general, the present disclosure may be summarized by a circuit, for example a circuit that can be integrated or incorporated in an electronic device such as for example the voltage converter 50, 150, which comprises: a switching circuit arranged between an input node at an input voltage and a reference potential node, and including a high-side switch circuit, a low-side switch circuit, and a phase node between the high-side switch circuit and the low-side switch circuit; and a driving circuit, wherein the driving circuit comprises: a high-side driver including a first supply node coupled to the input node, at least one output coupled to the high-side switch circuit, and configured to switch the high-side switch circuit; and a low-side driver including a first supply node coupled to the input node, at least one output coupled to the low-side switch circuit, and configured to switch the low-side switch circuit, wherein the high-side driver, to switch the high-side switch circuit, is configured to couple the respective at least one output to the respective first supply node; or wherein the low-side driver, to switch the low-side switch circuit, is configured to couple the respective at least one output to the first supply node.

The high-side driver may further comprise a second supply node coupled to a bootstrap node of a bootstrap capacitive element, wherein the high-side driver, to switch the high-side switch circuit, is configured to couple the respective at least one output to at least one of the respective first supply node and the respective second supply node.

The high-side driver may be configured to couple the respective at least one output to at least one of the respective first supply node and the respective second supply node, as a function of a difference between the input voltage and a voltage at the respective second supply node.

The high-side driver may comprise a coupling circuit configured to compare the voltage at the respective second supply node with the input voltage and, based on the comparison, couple the respective at least one output to the respective first supply node or decouple the respective at least one output from the respective first supply node.

The coupling circuit (96) of the high-side driver may be configured to couple the respective at least one output to the respective first supply node when the voltage at the respective second supply node is lower than the input voltage or to decouple the respective at least one output from the respective first supply node when the voltage at the respective second supply node is higher than the input voltage.

The coupling circuit of the high-side driver may comprise a series circuit arranged between the respective first supply node and the respective at least one output, wherein the series circuit comprises at least two transistors arranged in a back-to-back configuration with each other.

The low-side driver may further comprise a second supply node coupled to a driving node of the driving circuit, wherein the low-side driver, to switch the low-side switch circuit, is configured to couple the respective at least one output to at least one of the respective first supply node and the respective second supply node.

The driving circuit may comprise a sensing circuit configured to sense a voltage at a phase node which is arranged between the high-side switch circuit and the low-side switch circuit, and to provide a sensing signal indicative of the voltage at the phase node, wherein the low-side driver is configured to couple the respective at least one output to at least one of the respective first supply node and the respective second supply node, as a function of the sensing signal.

The low-side driver may comprise a coupling circuit configured to couple the respective at least one output to the respective first supply node when the sensing signal indicates that the voltage at the phase node is lower than a threshold.

The low-side switch circuit may comprise at least a first low-side switch and a second low-side switch, wherein the at least one output of the low-side driver is a first output of the low-side driver couplable to the first low-side switch, the low-side driver may further comprise a second output couplable to the second low-side switch, wherein the low-side driver, to switch the second low-side switch, is configured to couple the respective second output to the respective second supply node with a delay which is independent of the sensing signal.

The driving circuit may further comprise a driving voltage regulator, in embodiments capless, having a driving node and configured to provide a driving voltage to the driving node, the low-side driver being coupled to the driving node.

The driving voltage regulator may have a supply node couplable to the input node and a reference supply node, the driving voltage regulator comprising at least one of: an adaptive biasing circuit, a low clamp circuit, and a high clamp circuit, wherein the adaptive biasing circuit may be configured to provide a biasing current to the driving voltage regulator, the biasing current being a function of a difference between the driving voltage (V_{DRV}) and a reference driving value; the low clamp circuit may be configured to couple the driving node to the supply node of the driving voltage regulator, as a function of a difference between the driving voltage and the reference driving value; and the high clamp circuit may be configured to couple the driving node to the reference supply node of the driving voltage regulator, as a function of a difference between the driving voltage and the reference driving value.

The driving circuit may also comprise a bootstrap switch circuit configured to couple the driving node of the driving voltage regulator to the second supply node of the high-side driver for charging the bootstrap capacitive element.

The bootstrap switch circuit may be configured to couple the driving node to the second supply node of the high-side driver, as a function of the voltage at the phase node, in embodiments in response to sensing, by the sensing circuit, that the voltage at the phase node is lower than the threshold.

The present description may be further exemplified as follows:

Example 1. An electronic device (50; 150) comprising:

a switching circuit (55) arranged between an input node (51) at an input voltage (V_{IN}) and a reference potential node (62), and including a high-side switch circuit (HS), a low-side switch circuit (LS; LS’’), and a phase node (SW) between the high-side switch circuit and the low-side switch circuit; and a driving circuit (57; 157), wherein the driving circuit comprises: a high-side driver (90; 190) including a first supply node (94) coupled to the input node (51), at least one output (98) coupled to the high-side switch circuit (HS), and configured to switch the high-side switch circuit; and a low-side driver (91; 169) including a first supply node (111) coupled to the input node (51), at least one output (113; 172) coupled to the low-side switch circuit (LS; LS’’), and configured to switch the low-side switch circuit, wherein the high-side driver (90; 190), to switch the high-side switch circuit (HS), is configured to couple the respective at least one output (98) to the respective first supply node (94); or wherein the low-side driver (91; 169), to switch the low-side switch circuit (LS; LS’’), is configured to couple the respective at least one output (113; 172) to the first supply node (111).

Example 2. The electronic device according to the preceding example, wherein the switching circuit is a half-bridge circuit (55).

Example 3. The electronic device according to the example 1 or 2, wherein the high-side switch circuit and the low-side switch circuit each comprise at least one NMOS transistor (58, 63; 58, 163, 165).

Example 4. The electronic device according to the example 1-3, wherein the electronic device is a switching voltage converter (50; 150) configured to provide an output voltage (V_{OUT}) starting from the input voltage (V_{IN}), wherein the voltage converter further comprises a switching control circuit (60) configured to provide a high-side control signal (HS_PWM) and a low-side control signal (LS_PWM) as a function of a signal (FB) indicative of a difference between the output voltage (V_{OUT}) and a nominal voltage, the low-side driver (91; 169) being configured to switch the low-side switch circuit (LS; LS’’) as a function of the low-side control signal (LS_PWM), the high-side driver (90; 190) being configured to switch the high-side switch circuit (HS) as a function of the high-side control signal (HS_PWM).

Although the description has been described in detail, it should be understood that various changes, substitutions, and alterations may be made without departing from the spirit and scope of this disclosure as defined by the appended claims. The same elements are designated with the same reference numbers in the various figures. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

The specification and drawings are, accordingly, to be regarded simply as an illustration of the disclosure as defined by the appended claims, and are contemplated to cover any and all modifications, variations, combinations, or equivalents that fall within the scope of the present disclosure.

What is claimed is:

1. A driving circuit for a switching circuit, the switching circuit arranged between an input node and a reference potential node, the driving circuit comprising:
a high-side driver, comprising:
a first supply node couplable to the input node supplied by an input voltage, and
a first output node couplable to a high-side switch circuit of the switching circuit; and
a low-side driver, comprising:
a second supply node couplable to the input node, and
a second output node couplable to a low-side switch circuit of the switching circuit,
wherein the high-side driver is configured to switch the high-side switch circuit by coupling the first output node to the first supply node, and
wherein the low-side driver is configured to switch the low-side switch circuit by coupling the second output node to the second supply node.

2. The driving circuit of claim 1, wherein the high-side driver comprises a third supply node couplable to a bootstrap node of a bootstrap capacitive element, and wherein the high-side driver is configured to couple the first output node to the third supply node to switch the high-side switch circuit.

3. The driving circuit of claim 2, wherein the high-side driver is configured to couple the first output node to the first supply node and the third supply node as a function of a difference between the input voltage and a voltage at the third supply node.

4. The driving circuit of claim 3, wherein the high-side driver comprises a coupling circuit configured to:
couple the first output node to the first supply node in response to the voltage at the third supply node being lower than the input voltage; and
decouple the first output node from the first supply node in response to the voltage at the third supply node being greater than the input voltage.

5. The driving circuit of claim 4, wherein the coupling circuit comprises a series circuit arranged between the first supply node and the first output node, the series circuit comprising a first transistor and a second transistor arranged in a back-to-back configuration.

6. The driving circuit of claim 1, wherein the low-side driver comprises a fourth supply node coupled to a driving node of the driving circuit, and wherein the low-side driver is configured to couple the second output node to the fourth supply node to switch the low-side switch circuit.

7. The driving circuit of claim 1, wherein the low-side driver comprises a fourth supply node coupled to a driving node of the driving circuit, the driving circuit further comprising a sensing circuit configured to:
sense a voltage at a phase node arranged between the high-side switch circuit and the low-side switch circuit; and
provide a sensing signal indicative of the voltage at the phase node,
wherein the low-side driver is configured to couple the second output node to the second supply node as a function of the sensing signal.

8. The driving circuit of claim 7, wherein the low-side driver comprises a coupling circuit configured to couple the second output node to the second supply node in response to the sensing signal indicating that the voltage at the phase node is below a threshold.

9. The driving circuit of claim 8, wherein the low-side switch circuit comprises a first low-side switch and a second low-side switch, wherein the second output node is couplable to the first low-side switch, wherein the low-side driver comprises a third output node couplable to the second low-side switch, wherein the low-side driver is configured to couple the third output node to the fourth supply node with a delay independent of the sensing signal.

10. The driving circuit of claim 1, further comprising a capless driving voltage regulator having a driving node coupled to the low-side driver, the capless driving voltage regulator configured to provide a driving voltage to the driving node.

11. The driving circuit of claim 10, wherein the capless driving voltage regulator has a fifth supply node couplable to the input node and a reference supply node, the capless driving voltage regulator comprising:
an adaptive biasing circuit configured to provide a biasing current for the capless driving regulator as a function of a difference between the driving voltage and a reference driving value;
a low-clamp circuit configured to couple the driving node to the fifth supply node as a function of a difference between the driving voltage and the reference driving value; and
a high-clamp circuit configured to couple the driving node to the reference supply node as a function of a difference between the driving voltage and the reference driving value.

12. The driving circuit of claim 10, wherein the high-side driver comprises a third supply node couplable to a bootstrap node of a bootstrap capacitive element, the driving circuit comprising a bootstrap switch circuit configured to couple the driving node to the third supply node for charging a bootstrap capacitive element.

13. The driving circuit of claim 12, further comprising a sensing circuit configured to sense a voltage at a phase node arranged between the high-side switch circuit and the low-side switch circuit, wherein the bootstrap switch circuit is configured to couple the driving node to the third supply node as a function of a voltage at the phase node in response to sensing, by the sensing circuit, that the voltage at the phase node is lower than a threshold.
14. The driving circuit of claim 1, wherein the high-side driver is configured to couple the first output node to the first supply node to close the high-side switch circuit, and wherein the low-side driver is configured to couple the second output node to the second supply node to close the low-side switch circuit.

15. A driving circuit for a switching circuit arranged between an input node at an input voltage and a reference potential node and comprising a high-side switch circuit and a low-side switch circuit, the driving circuit comprising:
a high-side driver including a first supply node coupled to the input node, at least one output coupled to the high-side switch circuit, a second supply node coupled to a bootstrap node of a bootstrap capacitive element and configured to switch the high-side switch circuit; and
a low-side driver including a first supply node coupled to the input node, at least one output coupled to the low-side switch circuit, and configured to switch the low-side switch circuit,
wherein the high-side driver, to switch the high-side switch circuit, is configured to couple the respective at least one output to at least one of the respective first supply node and the respective second supply node.

16. The driving circuit of claim 15, wherein the high-side driver comprises a coupling circuit comprising a series circuit comprising at least two transistors arranged in a back-to-back configuration with each other, wherein the coupling circuit is configured to couple the respective at least one output to at least one of the respective first supply node and the second supply node when the voltage at the respective second supply node is lower than the input voltage and to decouple the respective at least one output from the at least one of the respective first supply node and the second supply node when the voltage at the respective second supply node is higher than the input voltage.

17. A driving circuit for a switching circuit arranged between an input node at an input voltage and a reference potential node and comprising a high-side switch circuit and a low-side switch circuit, the driving circuit comprising:
a high-side driver including a first supply node coupled to the input node, at least one output coupled to the high-side switch circuit, and configured to switch the high-side switch circuit; and
a low-side driver including a first supply node coupled to the input node, at least one output coupled to the low-side switch circuit, a second supply node coupled to a driving node of the driving circuit, and configured to switch the low-side switch circuit,
wherein the low-side driver, to switch the low-side switch circuit, is configured to couple the respective at least one output to at least one of the respective first supply node and the respective second supply node.

18. The driving circuit of claim 17, comprising a sensing circuit configured to sense a voltage at a phase node which is arranged between the high-side switch circuit and the low-side switch circuit, and provide a sensing signal representative of the voltage at the phase node, wherein the low-side driver is configured to couple the respective at least one output to at least of the respective first supply node and the respective second supply node as a function of the sensing signal.

19. The driving circuit of claim 18,
wherein the low-side switch circuit comprises at least a first low-side switch and a second low-side switch,
wherein the at least one output of the low-side driver is a first output of the low-side driver coupled to the first low-side switch, the low-side driver further comprising a second output coupled to the second low-side switch, and
wherein the low-side driver, to switch the second low-side switch, is configured to couple the respective second output to the respective second supply node with a delay independent of the sensing signal.

20. The driving circuit of claim 17, further comprising a capless driving voltage regulator connected to the driving node and configured to provide a driving voltage to the driving node.
